(19) United States
(12) Patent Application Publication
(10) Pub. No.: US 2026/0087762 A1
(43) Pub. Date: Mar. 26, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KANAKO KANEDA, Kanagawa (JP)

(21) Appl. No.: 19/331,279

(22) Filed: Sep. 17, 2025

(30) Foreign Application Priority Data
Sep. 24, 2024 (JP) 2024-165517

(51) Int. Cl. G06V 10/10; G06F 3/0484; G06T 11/60; G06V 10/12

(52) U.S. Cl. CPC G06V 10/19; G06F 3/0484; G06T 11/60; G06V 10/12

(57) ABSTRACT

An information processing apparatus includes one or more memories storing instructions and one or more processors. The processors function as: a determination unit configured to determine a reading device for reading encoded information from among a plurality of the reading devices, the reading devices being connectable to the information processing apparatus; a display control unit configured to cause a display unit to display a guide screen corresponding to the reading device determined by the determination unit from among the plurality of connectable reading devices; and a control unit configured to perform control for reading the encoded information by using the determined reading device.

### BACKGROUND

### Field of the Technology

The present disclosure relates to an information processing apparatus, and a method of controlling an information processing apparatus, and a storage medium.

### Description of the Related Art

In recent years, certain codes, such as QR codes (registered trademark), which are obtained by encoding information (hereinafter referred to as “two-dimensional codes”) have been utilized as a method for inputting information into information processing apparatuses. For image forming apparatuses, such as multi-function peripherals (MFPs), as an example of the information processing apparatuses, two-dimensional codes containing job setting information for copying, printing, or the like or login information can be utilized as input information. Japanese Patent Laid-Open No. 2024-097671 discloses a technique for logging into an image forming apparatus using a two-dimensional code.

There is a demand to improve the usability of information processing apparatuses which use encoded information as input information.

### SUMMARY

An information processing apparatus according to an aspect of the present disclosure includes: one or more memories storing instructions; and one or more processors which function as: a determination unit configured to determine a reading device for reading encoded information from among a plurality of the reading devices, the reading devices being connectable to the information processing apparatus; a display control unit configured to cause a display unit to display a guide screen corresponding to the reading device determined by the determination unit from among the plurality of connectable reading devices; and a control unit configured to perform control for reading the encoded information by using the reading device determined by the determination unit.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are block diagrams illustrating a hardware configuration of an image forming apparatus.

FIG. 2 is a block diagram illustrating a software configuration of the image forming apparatus.

FIG. 3 is a diagram illustrating an operation screen of on the image forming apparatus.

FIG. 4 is a diagram illustrating an example of a two-dimensional code.

FIG. 5 is a flowchart illustrating an example of processing by an application.

FIG. 6 is a flowchart illustrating details of a process of determining a code reading device.

FIG. 7 is a flowchart illustrating details of a code reading process for reading a two-dimensional code.

FIGS. 8A and 8B are diagrams illustrating an example of code reading guide screens.

FIGS. 9A and 9B are diagrams illustrating an example of code reading error screens.

FIGS. 10A and 10B are diagrams illustrating an example of two-dimensional codes.

FIG. 11 is a diagram showing the relationship of FIGS. 11A and 11B.

FIGS. 11A and 11B are totally a flowchart illustrating details of a code reading process for reading a two-dimensional code or codes.

FIGS. 12A and 12B are diagrams illustrating code reading guide screens.

FIG. 13 is a block diagram illustrating a hardware configuration of an image forming apparatus.

FIG. 14 is a flowchart illustrating details of a code reading device determination process.

FIG. 15 is a diagram showing the relationship of FIGS. 15A and 15B.

FIGS. 15A and 15B are totally a flowchart illustrating details of processing for executing a code reading process.

FIGS. 16A and 16B are diagrams illustrating an example of code reading error screens.

FIG. 17 is a flowchart illustrating details of a code reading device determination process.

FIGS. 18A and 18B are diagrams illustrating an example of code reading guide screens.

FIG. 19 is a flowchart illustrating details of a device determination process.

FIG. 20 is a flowchart illustrating details of a code reading device determination process.

FIG. 21 is a flowchart illustrating details of processing for executing a code reading process.

FIGS. 22A and 22B are diagrams illustrating an example of a code reading guide screen.

### DESCRIPTION OF THE EMBODIMENTS

Embodiments of the present disclosure will now be specifically described below with reference to the accompanying drawings. Note that the following embodiments do not limit the contents of the present disclosure, and not all of the combinations of the features described in the following embodiments are necessarily essential for the solution to be provided by the present disclosure. Note that identical constituent elements are denoted by the same reference numeral.

### First Embodiment

### <Overview>

Two-dimensional codes obtained by encoding information have been utilized as a method for inputting information into information processing apparatuses. Examples of devices for reading two-dimensional codes for such information processing apparatuses include general-purpose cameras, such as webcams, and dedicated devices for reading one-dimensional codes, such as barcodes, or two-dimensional codes (hereinafter referred to as “code scanners”). Such cameras and code scanners, which serve as devices for reading codes such as two-dimensional codes, have become diversified in recent years. Thus, in a case where a user causes an information processing apparatus to read a two-dimensional code, the user is required to present the two-dimensional code in an appropriate manner for one of various reading devices which the information processing apparatus is equipped with. For example, in a case where the information processing apparatus can be equipped with either a camera or a code scanner, there is a possibility of impairing user operability if an appropriate reading instruction is not provided for the two-dimensional code reading device.

Thus, there is a demand to improve the usability of information processing apparatuses which use encoded information as input information. In a first embodiment, an example will be described in which, the user of an information processing apparatus is notified of a two-dimensional code reading guide suitable for the two-dimensional code reading device utilized by the information processing apparatus according to the type of the two-dimensional code reading device. This makes it easy for the user to read a two-dimensional code with the information processing apparatus without impairing user operability. Specific configurations of the embodiment will now be described below.

### <Configurations>

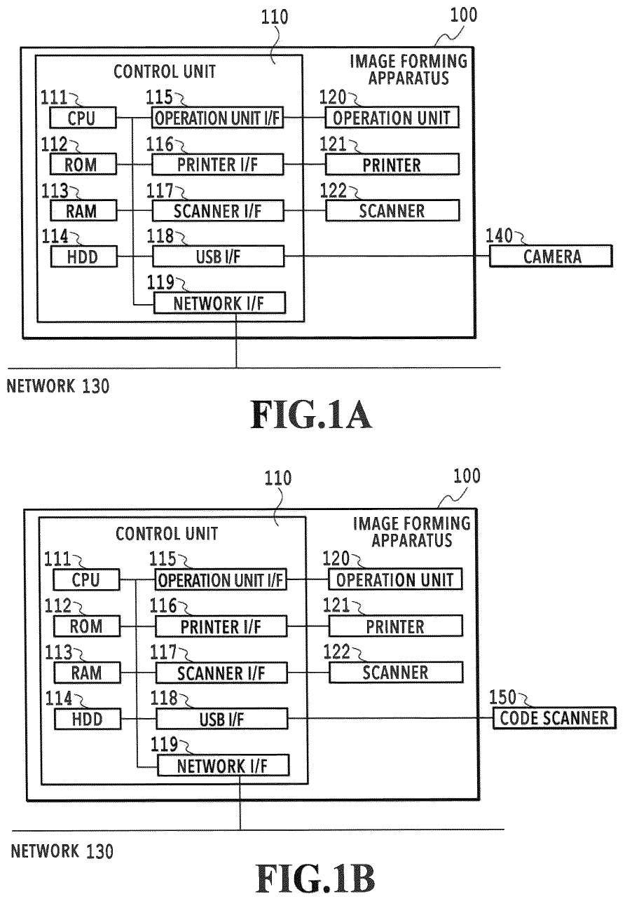

FIGS. 1A and 1B are block diagrams illustrating hardware configurations of an image forming apparatus as an example of an information processing apparatus according to the present embodiment. FIG. 1A is a configuration example in which a camera is provided as a two-dimensional code reading device connected to the information processing apparatus. FIG. 1B is a configuration example in which a code scanner is provided as a two-dimensional code reading device connected to the information processing apparatus. The present embodiment will be described by taking an image forming apparatus 100 as an example of the information processing apparatus. The image forming apparatus is an MFP, for example. Note that the present embodiment is applicable not only to image forming apparatuses such as MFPs but also to various information processing apparatuses equipped with code reading processing functions, such as computers.

The hardware configuration of the image forming apparatus 100 to which a camera is connected will now be described using FIG. 1A. The image forming apparatus 100 is an MFP having various job execution functions, such as a printer function, a copy function, and a scanner function. The image forming apparatus 100 has a control unit 110, an operation unit 120, a printer 121, and a scanner 122.

The control unit 110 has a central processing unit (CPU) 111, a read-only memory (ROM) 112, a random-access memory (RAM) 113, a hard disk drive (HDD) 114, an operation unit interface (I/F) 115, a printer I/F 116, a scanner I/F 117, a universal serial bus (USB) I/F 118, and a network I/F 119. The elements in the control unit 110 are connected to one another by a system bus not illustrated.

The CPU 111 controls the entire system of the image forming apparatus 100. The ROM 112 stores a system boot program. The RAM 113 is a system work memory for the operation of the CPU 111 and is a memory for temporarily storing print image data, scan image data, setting data, and the like. Also, the RAM 113 stores programs such as an operating system, system software, and application software and their data as well. The HDD 114 stores an operating system, system software, application software, various pieces of image data, and the like.

The operation unit I/F 115 is a part serving as an interface with the operation unit 120, and outputs, to the operation unit 120, screen data to be displayed on the display screen of a touch panel of the operation unit 120 and accepts information input on the touch panel by the user. The operation unit 120 is a display unit that displays screen information output from the control unit 110 and also a reception unit that receives operations from the user.

The printer I/F 116 is a part serving as an interface with the printer 121. The scanner I/F 117 is a part serving as an interface with the scanner 122. The control unit 110 obtains image data of a document by controlling the scanner 122 via the scanner I/F 117, and prints an image on a sheet by controlling the printer 121 via the printer I/F 116.

The USB I/F 118 is a part serving as an interface with a USB device externally connected to the image forming apparatus 100. In FIG. 1A, a camera 140 is connected to the USB I/F 118. The camera 140 is a camera device, such as a webcam, and is capable of capturing a still image or a moving image of the surroundings of the image forming apparatus 100. The control unit 110 controls the image capture of the camera 140 via the USB I/F 118. The captured image data captured by the camera 140 is stored in the RAM 113 or the HDD 114. Applications that run on the image forming apparatus 100 are capable of using the captured image data stored in the RAM 113 or the HDD 114 to execute processes that use camera images.

The present embodiment assumes that a USB device complying with a USB Video Class (UVC) standard is utilized as the camera 140. The UVC is a camera driver provided by the operating system, and has an interface that controls the image capture of the camera via a system call.

The network I/F 119 is a part serving as an interface with a network 130 and controls communication with information processing apparatuses, cloud servers, and the like connected to the image forming apparatus 100 through the network. The network 130 is the Internet, for example.

Next, the hardware configuration of the image forming apparatus 100 to which a code scanner 150 is connected will be described using FIG. 1B. In FIG. 1B, the code scanner 150 is externally connected to the image forming apparatus 100 through the USB I/F 118. The code scanner 150 is a code scanner device for reading one-dimensional codes, such as barcodes, or two-dimensional codes. The control unit 110 controls the code reading of the code scanner 150 via the USB I/F 118. The present embodiment assumes that a USB device complying with a human interface device (HID) class standard is utilized as the code scanner. The HID recognizes the code scanner 150 connected to the control unit 110 as a human interface device similar to a keyboard. Applications that run on the image forming apparatus 100 are capable of obtaining read code data as input data like keyboard input.

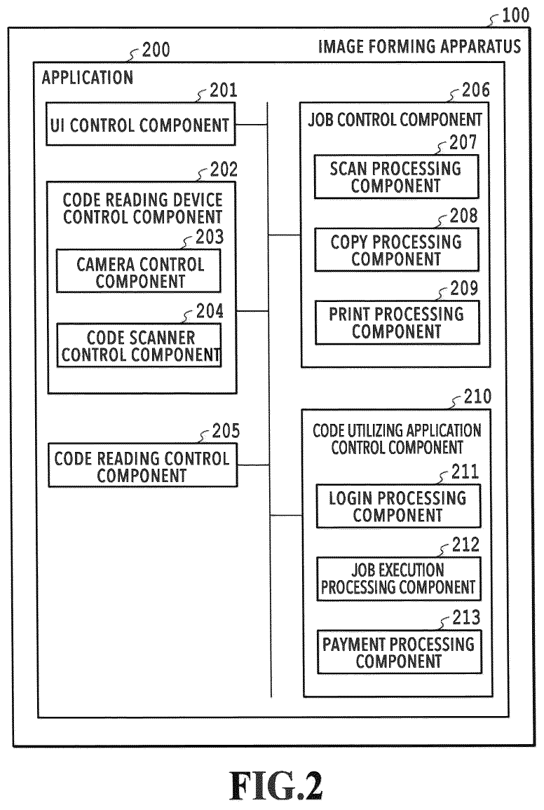

FIG. 2 is a block diagram illustrating a software configuration of the image forming apparatus 100 according to the present embodiment. An application 200 is software that is executed by the CPU 111 of the control unit 110, and is stored in the ROM 112, the RAM 113, the HDD 114, or the like. The application 200 is a code utilizing application that utilizes codes. The application 200 has a user interface (UI) control component 201, a code reading device control component 202, a code reading control component 205, a job control component 206, and a code utilizing application control component 210.

The UI control component 201 receives input operations on the touch panel of the operation unit 120 by the user and sends the received data to various pieces of software in the application 200. Also, the UI control component 201 receives responses from the various pieces of software in the application 200 and performs display control for creating and displaying display screen data for the operation unit 120.

The code reading device control component 202 has a camera control component 203 and a code scanner control component 204, and controls the code reading device for reading two-dimensional codes. Which control component to use, the camera control component 203 or the code scanner control component 204, is determined based on the connection state of the code reading control component 205. For example, in a state where the code reading control component 205 is connected to the camera 140, the camera control component 203 is utilized. In a state where the code reading control component 205 is connected to the code scanner 150, the code scanner control component 204 is utilized.

The camera control component 203 performs control for activation and deactivation of the camera 140 and control for starting and stopping of capture of a still image or a moving image. The camera control component 203 sends image data captured by the camera 140 (hereinafter referred to as “camera image data”) to the UI control component 201. In this way, the camera image data can be displayed on the display screen of the operation unit 120. An image represented by camera image data will be referred to as “camera image” or “captured image.” Also, the camera control component 203 sends camera image data captured by the camera 140 in which a two-dimensional code is included as a subject to the code reading control component 205. In this way, the code reading control component 205 can perform a two-dimensional code detection process using the camera image.

Further, the camera control component 203 notifies the UI control component 201 of the start and stop of image capture by the camera 140. In response to this notification, the UI control component 201 can display a status indicator indicating that the camera 140 is capturing an image on the display screen of the operation unit 120.

Note that the use of the camera control component 203 is not limited to code reading. Software in the application 200 is capable of executing a process utilizing a still camera image or a moving camera image (e.g., login to the image forming apparatus 100 by facial authentication) via the camera control component 203. Also, software in the application 200 is capable of executing a process of displaying a still camera image or a still moving image on a screen and a process of displaying a status indicating that the camera is capturing an image via the UI control component 201.

The code scanner control component 204 controls activation and deactivation of the code scanner 150 and obtains data of a two-dimensional code detected by the code scanner 150.

The code reading control component 205 analyzes the camera image data received from the camera control component 203 and detects the position and shape of the two-dimensional code included in the camera image data. Also, the code reading control component 205 analyzes the two-dimensional code detected from the camera image data and obtains the data contained in the two-dimensional code. The obtained data is sent to the code utilizing application control component 210.

Similarly, the code reading control component 205 obtains the data contained in the two-dimensional code detected by the code scanner control component 204 and sends it to the code utilizing application control component 210. Also, the code reading control component 205 is capable of determining whether the data contained in the two-dimensional code is divided and contained in multiple two-dimensional codes and, if so, generating a single piece of data by joining the multiple detected two-dimensional codes.

The job control component 206 has a scan processing component 207, a copy processing component 208, and a print processing component 209, and controls the scanner 122 and the printer 121 to execute various jobs, such as scanning, copying, and printing.

The code utilizing application control component 210 obtains the data of the two-dimensional code received from the code reading control component 205 and executes processes for various applications that utilize the obtained data. In the present embodiment, the code utilizing application control component 210 has a login processing component 211, a job execution processing component 212, and a payment processing component 213. The login processing component 211 executes a login process that utilizes user information, such as a user name and a password, contained in the two-dimensional code. The job execution processing component 212 utilizes job setting information for copying, printing, or the like contained in the two-dimensional code to execute a job execution process using the job setting information with the job control component 206. The payment processing component 213 utilizes payment information contained in the two-dimensional code to execute a payment process for the job executed by the job control component 206.

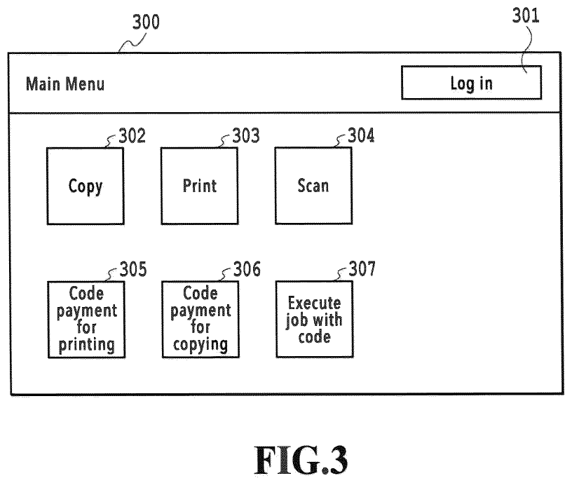

FIG. 3 is a diagram illustrating an example of an operation screen on the image forming apparatus 100 in the present embodiment. A screen 300 in FIG. 3 is a main menu screen displayed on the display screen of the operation unit 120 of the image forming apparatus 100. The screen 300 displays various buttons, namely a “Login” button 301 for executing a login process and a “Copy” button 302, a “Print” button 303, and a “Scan” button 304 for executing various jobs. The screen 300 further displays various buttons for executing various code utilizing applications, namely a “Code payment for printing” button 305, a “Code payment for copying” button 306, and an “Execute job with code” button 307.

The “Code payment for printing” button 305 is a button for executing processing by the payment processing component 213. In response to a press on the “Code payment for printing” button 305, the payment processing component 213 executes a payment process for a print job to be executed by the print processing component 209 by using the payment information contained in the two-dimensional code.

The “Code payment for copying” button 306 is a button for executing processing by the payment processing component 213. In response to a press on the “Code payment for copying” button 306, the payment processing component 213 executes a payment process for a copy job to be executed by the copy processing component 208 by using the payment information contained in the two-dimensional code.

The “Execute job with code” button 307 is a button for executing processing by the job execution processing component 212. In response to a press on the “Execute job with code” button 307, the job execution processing component 212 executes a job to be executed by using the job setting information contained in the two-dimensional code.

In response to detecting a press on any of the “Login” button 301, the “Code payment for printing” button 305, the “Code payment for copying” button 306, and the “Execute job with code” button 307, the UI control component 201 displays a two-dimensional code reading guide screen to be described later on the display screen of the operation unit 120. Then, the code reading control component 205 starts a two-dimensional code reading process, and processes for various code utilizing applications that utilize the data obtained by reading the two-dimensional code are executed.

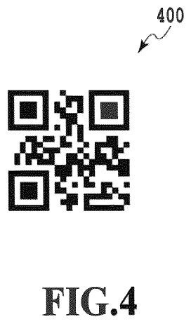

FIG. 4 is a diagram illustrating an example of a two-dimensional code according to the present embodiment. In the present embodiment, an example using a two-dimensional code as encoded information, which is information subjected to encoding, will be described. Also, the description will be given using a QR code (registered trademark) as the two-dimensional code. Here, the encoded information is not limited to this example. A different type of one-dimensional code or two-dimensional code may be used as the encoded information.

A two-dimensional code 400 is a matrix-shaped two-dimensional code and is formed of black and white squares (called cells) as its smallest units. As indicated by the two-dimensional code 400, various pieces of information including format information such as position detection patterns, a timing pattern, and an error correction level, and data or the like are embedded as the encoded information by combining cells.

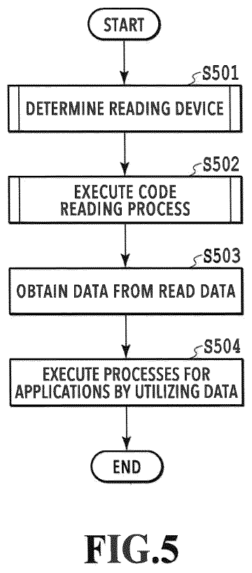

FIG. 5 is a flowchart illustrating an example of processing by the application 200 according to the present embodiment. The CPU 111 of the image forming apparatus 100 implements the processing illustrated in FIG. 5 by functioning as the functional components of the application 200 illustrated in FIG. 2, as mentioned earlier. That is, the CPU 111 implements the flowchart of FIG. 5 by reading out a program stored in the ROM 112, the HDD 114, or the like into the RAM 113 and executing it. Incidentally, the functions of some or all of the steps in FIG. 5 may be implemented with hardware, such as an application-specific integrated circuit (ASIC) or an electronic circuit. The symbol “S” in the description of each process means a step in the flowchart (the same applies to the other flowcharts herein).

FIG. 5 is a flowchart of the entire processing by the application 200. More specifically, FIG. 5 is a flowchart of processing in which a two-dimensional code, which is encoded information, is utilized as an input. The processing in the flowchart illustrated in FIG. 5 is started in response to a press on one of the various code utilizing application buttons on the screen 300 illustrated in FIG. 3. Specifically, the processing in the flowchart illustrated in FIG. 5 is started in response to a press on one of the “Login” button 301, the “Code payment for printing” button 305, the “Code payment for copying” button 306, or the “Execute job with code” button 307.

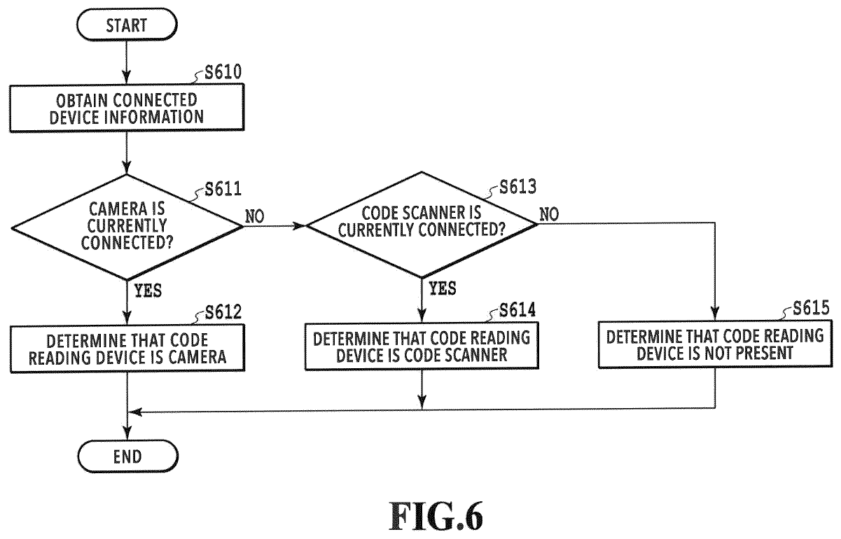

In S501, the code reading control component 205 determines the code reading device to utilize to read the two-dimensional code. Details of the process of S501 will be described later using FIG. 6.

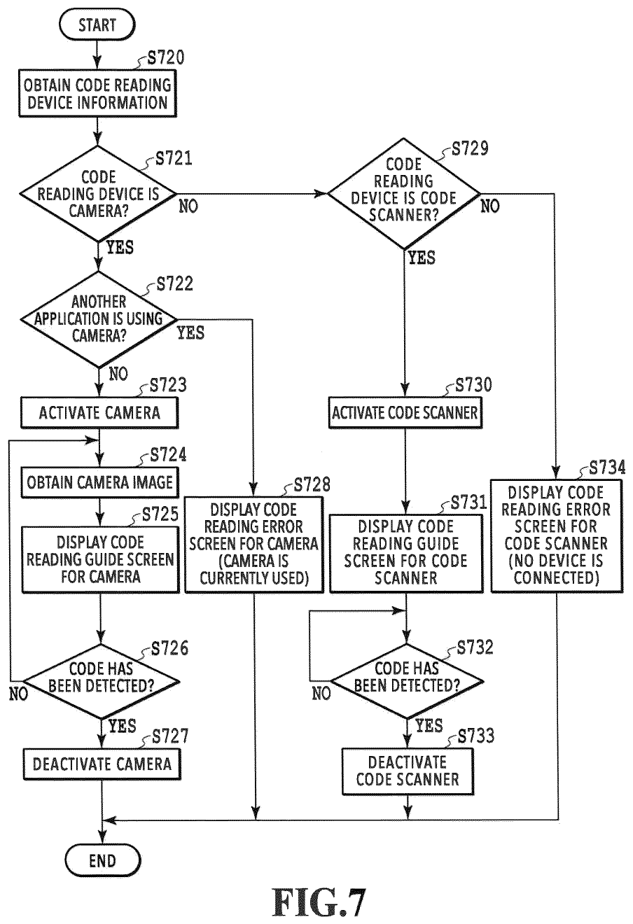

In S502, the code reading control component 205 executes a code reading process with the camera control component 203 or the code scanner control component 204 of the code reading device control component 202 according to the type of the code reading device determined in S501. In this process of S502, the code reading control component 205 causes the UI control component 201 to execute a process of displaying a code reading guide screen corresponding to the type of the code reading device. The UI control component 201 displays the code reading guide screen corresponding to the type of the code reading device on the display screen of the operation unit 120. Details of the process of S502 will be described later using FIG. 7.

In S503, the code reading control component 205 obtains the data contained in the read two-dimensional code and sends it to the code utilizing application control component 210. For example, the code reading control component 205 decodes the data of the two-dimensional code, which is encoded information, and sends the decoded data to the code utilizing application control component 210. In S504, the code utilizing application control component 210 executes processing for various applications by utilizing the data received from the code reading control component 205. For example, in a case of executing the application for code payment for printing, the payment processing component 213 executes a payment process for an executed print job based on payment ID information obtained from the data obtained by reading the two-dimensional code. Incidentally, in this case, the print job has already been executed by processing other than the processing in the flowchart of FIG. 5. Also, the print job has been sent to the image forming apparatus 100 and stored in a cloud server in separate processes. The print job has been executed based on other user operations or the like on the image forming apparatus 100. Note that, in the present embodiment, processing related to the reading of the two-dimensional code will be mainly described, and detailed description of the print job is therefore omitted. After finishing the process of S505, the application 200 terminates the processing in the flowchart illustrated in FIG. 5.

FIG. 6 is a flowchart illustrating details of the process of determining the code reading device in S501 in FIG. 5.

In S610, the code reading control component 205 obtains connected device information indicating which of the camera 140 and the code scanner 150 is connected. Also, the camera control component 203 and the code scanner control component 204 each identify whether the camera 140 or the code scanner 150 is connected to the USB I/F 118. The code reading control component 205 obtains the connection state of the camera 140 or the code scanner 150 identified by the camera control component 203 and the code scanner control component 204 as the connected device information. For example, in a case where the camera 140 is connected, the code reading control component 205 is notified by the camera control component 203 that the camera 140 is connected.

In S611, the code reading control component 205 determines whether the camera 140 is currently connected based on the connected device information obtained in S610. The code reading control component 205 proceeds to S612 if determining that the camera 140 is currently connected (Yes in S611). The code reading control component 205 proceeds to S613 if determining that the camera 140 is not currently connected (No in S611). In S613, the code reading control component 205 determines that the code reading device is the camera 140. Then, the code reading control component 205 terminates the processing in the flowchart illustrated in FIG. 6.

In S613, the code reading control component 205 determines whether the code scanner 150 is currently connected based on the connected device information obtained in S610. The code reading control component 205 proceeds to S614 if determining that the code scanner 150 is currently connected (Yes in S613). The code reading control component 205 proceeds to S615 if determining that the code scanner 150 is not currently connected (No in S613).

In S614, the code reading control component 205 determines that the code reading device is the code scanner 150. Then, the code reading control component 205 terminates the processing in the flowchart illustrated in FIG. 6. In S615, the code reading control component 205 determines that the code reading device is not present. Then, the code reading control component 205 terminates the processing in the flowchart illustrated in FIG. 6.

FIG. 7 is a flowchart illustrating details of the code reading process for reading the two-dimensional code in S502 in FIG. 5.

In S720, the code reading control component 205 obtains code reading device information representing information on the code reading device determined by the code reading device determination process illustrated in FIG. 6.

In S721, the code reading control component 205 determines whether the code reading device information obtained in S720 indicates the camera 140. The code reading control component 205 proceeds to S722 if determining that the code reading device information indicates the camera 140 (Yes in S721). The code reading control component 205 proceeds to S729 if determining that the code reading device information does not indicate the camera 140 (No in S721).

In S722, the code reading control component 205 determines whether another application is using the camera 140. Specifically, the code reading control component 205 inquires of the camera control component 203 whether another application is using the camera 140. The code reading control component 205 proceeds to S723 if determining that another application is not using the camera 140 (No in S722). The code reading control component 205 proceeds to S728 if determining that another application is using the camera 140 (Yes in S722).

In S723, the code reading control component 205 activates the camera 140. Specifically, the code reading control component 205 instructs the camera control component 203 to start a camera image capture process. In S723, the camera control component 203 activates the camera 140 based on the instruction from the code reading control component 205 and notifies the UI control component 201 that camera has started capturing an image.

Then, in S724, the camera control component 203 obtains camera image data by the camera image capture process and sends the obtained camera image data to the code reading control component 205 and the UI control component 201.

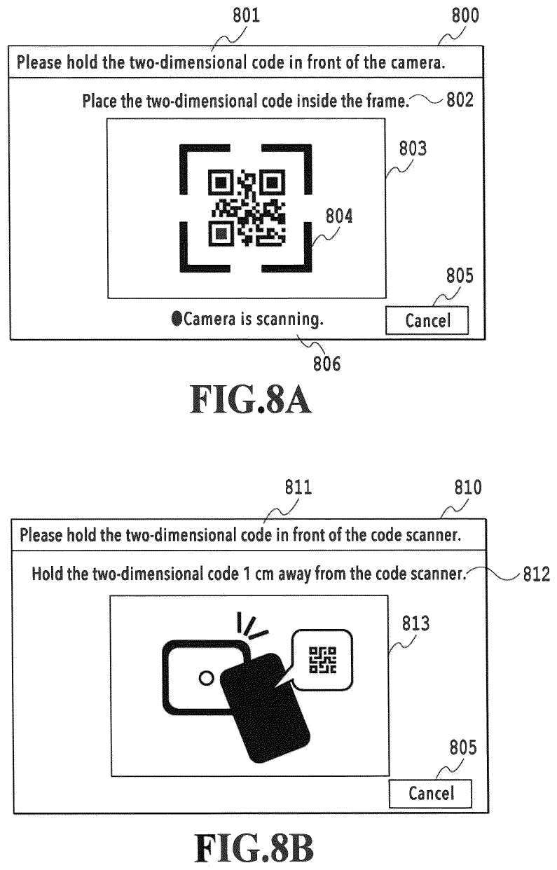

Then, in S725, the UI control component 201 displays a code reading guide screen for the camera on the display screen of the operation unit 120. At this time, the UI control component 201 displays, on the code reading guide screen for the camera, the camera image represented by the camera image data obtained from the camera control component 203 and a status indicator indicating that the camera 140 is capturing an image. Details will be described later using FIG. 8A.

Then, in S726, the code reading control component 205 executes a process of detecting a two-dimensional code from the camera image data obtained in S724, and determines whether a two-dimensional code has been detected. The code reading control component 205 proceeds to S727 if determining that a two-dimensional code has been detected from the camera image data (Yes in S726). The code reading control component 205 returns to S724 if determining that no two-dimensional code has been detected from the camera image data (No in S726).

In S727, the code reading control component 205 finishes the camera image capture process with the camera control component 203. The camera control component 203 deactivates the camera 140 and notifies the UI control component 201 that the image capture by the camera has been stopped. Then, the code reading control component 205 terminates the processing in the flowchart illustrated in FIG. 7.

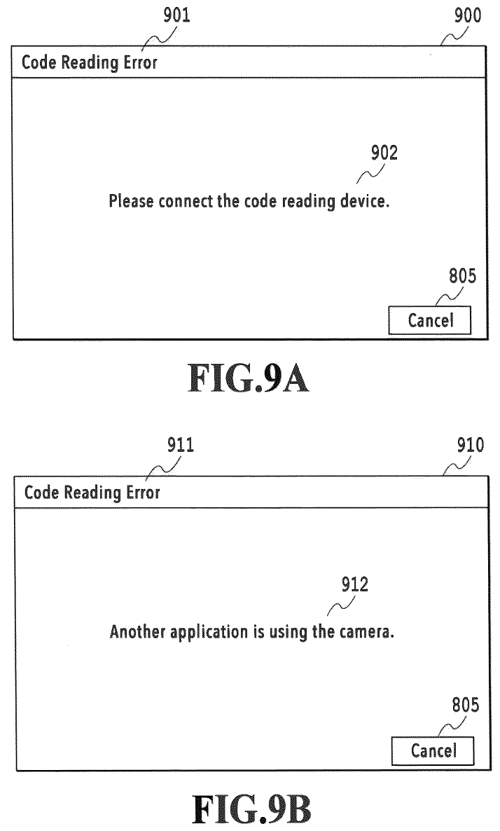

Next, the process of S728 in the case where it is determined in S722 that another application is using the camera will be described. In S728, the UI control component 201 displays a code reading error screen for the camera on the display screen of the operation unit 120. At this time, the UI control component 201 indicates that the camera 140 is currently used. Details will be described later using FIG. 9B. Then, the code reading control component 205 terminates the processing in the flowchart illustrated in FIG. 7.

Next, the process of S729 in the case where it is determined in S721 that the code reading device is not the camera 140 will be described. In S729, the code reading control component 205 determines whether the code reading device information obtained in S720 indicates the code scanner 150. The code reading control component 205 proceeds to S730 if determining that the code reading device information indicates the code scanner 150 (Yes in S729). The code reading control component 205 proceeds to S734 if determining that the code reading device information does not indicate the code scanner 150 (No in S729).

In S730, the code reading control component 205 activates the code scanner 150. Specifically, the code reading control component 205 instructs the code scanner control component 204 to start a code detection process. The code scanner control component 204 activates the code scanner 150 based on the instruction from the code reading control component 205.

Then, in S731, the UI control component 201 displays a code reading guide screen for the code scanner on the display screen of the operation unit 120. Details will be described later using FIG. 8B.

Then, in S732, the code reading control component 205 determines whether the code detection process by the code scanner control component 204 has been completed. The code reading control component 205 proceeds to S733 if determining that the code scanner control component 204 has detected a two-dimensional code (Yes in S732). The code reading control component 205 returns to S732 if determining that the code scanner control component 204 has not detected a two-dimensional code (No in S732).

In S733, the code reading control component 205 terminates the code detection process by the code scanner control component 204. The code scanner control component 204 deactivates the code scanner 150. Then, the code reading control component 205 terminates the processing in the flowchart illustrated in FIG. 7.

In S734, the UI control component 201 displays a code reading error screen on the display screen of the operation unit 120. The UI control component 201 indicates that neither the camera 140 nor the code scanner 150 is connected. Details will be described later using FIG. 9A. Then, the code reading control component 205 terminates the processing in the flowchart illustrated in FIG. 7.

FIGS. 8A and 8B are diagrams illustrating an example of the code reading guide screens according to the present embodiment. The code reading guide screens are screens for notifying of a guide for the reading of a two-dimensional code reading. The code reading guide screens are also instruction screens for instructing the user to read the two-dimensional code. FIG. 8A is an example of a code reading guide screen 800 for the camera displayed in S725. The code reading guide screen 800 is a screen displayed on the display screen of the operation unit 120 of the image forming apparatus 100. The code reading guide screen 800 has a title region 801, a message region 802, an image region 803, a cancel button 805, and a status region 806.

In the title region 801 and the message region 802, text is displayed which helps the user hold a two-dimensional code in front of the camera 140. For example, text as an instruction on how to present the two-dimensional code and text describing where the camera 140 of the image forming apparatus 100 is placed (not illustrated) are displayed.

In the image region 803, the camera image data obtained by the camera control component 203 is displayed while being updated in real time. Also, in the image region 803, a frame 804 that makes it easier to present the two-dimensional code is displayed in a superimposed manner over the captured image.

The cancel button 805 is a button for terminating the code reading process using the camera 140. In response to a press on the cancel button 805, the code reading control component 205 terminates the code reading process, and the UI control component 201 closes the code reading guide screen 800 and brings the display screen of the operation unit 120 back to the screen 300, or the main menu screen.

In the status region 806, text indicating that the camera 140 is capturing an image, is displayed, since the camera control component 203 has started imaging. By confirming the status indicator displayed in the status region 806 of the code reading guide screen 800, the user can recognize that the camera 140 is capturing an image.

FIG. 8B is an example of the code reading guide screen for the code scanner displayed in S731. A code reading guide screen 810 has a title region 811, a message region 812, an image region 813, and a cancel button 805.

In the title region 811 and the message region 812, text is displayed which helps the user hold a two-dimensional code in front of the code scanner 150 is displayed. For example, text as an instruction on how to present the two-dimensional code and text describing where the code scanner 150 of the image forming apparatus 100 is placed (not illustrated) are displayed. In the image region 813, an icon image for holding a two-dimensional code in front of the code scanner 150 is displayed, unlike the image displayed for the camera.

As described above, in the present embodiment, a code reading guide screen corresponding to the type of the code reading device connected to the image forming apparatus 100 is displayed. In this way, the user can easily recognize how to scan the two-dimensional code.

FIGS. 9A and 9B are diagrams illustrating an example of the code reading error screens according to the present embodiment. FIG. 9A is an example of the code reading error screen displayed in S734 in the case where no code reading device is connected. A code reading guide screen 900 has a title region 901 and message region 902 indicating a reading error and a cancel button 805. FIG. 9B is an example of the code reading error screen displayed in S728 in the case where another application is using the camera 140. A code reading guide screen 910 has a title region 911 and message region 912 indicating that another application is using the camera, and a cancel button 805.

As described above, in the present embodiment, the code reading guide screen to be displayed can be switched between the one for the camera and the one for the code scanner according to the type of the code reading device determined. In this way, it is possible to improve the usability of the information processing apparatus, which uses encoded information as input information. That is, it is possible to make it easy to read a two-dimensional code without impairing user operability.

Also, in the present embodiment, an example in which a camera image is displayed on the code reading guide screen 800 for the camera has been presented, but whether or not to display the camera image may be determined based on an automatic or manual setting. For example, in a case where the operation unit 120 of the image forming apparatus 100 has a small display screen, it may be difficult to view the camera image displayed on the code reading guide screen. For this reason, whether or not to display the camera image may be automatically switched according to the size of the display screen. Even without the camera image displayed on the display screen, the user can still recognize that the camera is capturing an image as long as the display screen includes the status indicator indicating that the camera is capturing an image.

Similarly, in the present embodiment, an example in which a status indicating that the camera is capturing an image is displayed on the code reading guide screen 800 for the camera has been presented, but whether or not to display the status indicator may be determined based on an automatic or manual setting.

Also, in the present embodiment, an example in which the code reading guide screen to be displayed is switched according to the type of the code reading device has been presented, but voice guidance for the code reading instruction may be switched via an audio output (not illustrated) included in the operation unit 120 of the image forming apparatus 100. Also, voice guidance for the code reading instruction may be switched via both the display of the code reading guide screen and the audio output according to the type of the code reading device.

### Second Embodiment

The first embodiment has described an example in which the code reading device is determined based on connection information of a camera or a code scanner connected to the image forming apparatus, and the code reading guide screen is switched according to the type of the code reading device determined. A second embodiment will describe an example in which the code reading guide screen is switched according to the type of the code reading device and additionally to the type of the application that utilizes the code. Examples of the type of the application that utilizes the code include a login application, a code payment application, and a code job execution application. While these applications are those executed in the image forming apparatus 100, applications corresponding to these are also stored in an information processing terminal apparatus possessed by the user who utilizes the image forming apparatus 100.

The basic configuration and processing in the second embodiment are similar to the example described in the first embodiment, and therefore description thereof will be omitted and the difference will be mainly described.

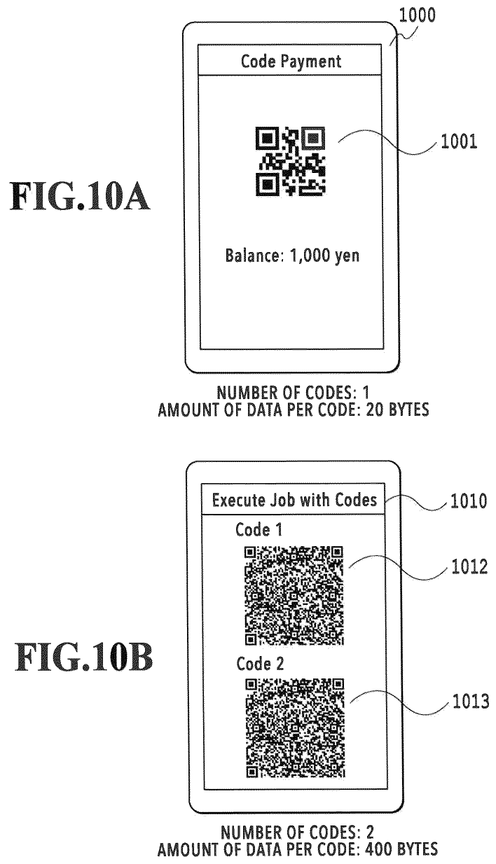

FIGS. 10A and 10B are diagrams illustrating an example of two-dimensional codes according to the present embodiment. A two-dimensional code to be utilized by the code payment application will now be described using FIG. 10A. Code payment refers to payment that is performed using a payment code, such as a two-dimensional code. A two-dimensional payment code contains payment ID information. The code payment application in the image forming apparatus 100 is capable of executing various services, such as payments, charging, and balance checks by using payment ID information obtained from a two-dimensional payment code presented by the user. A screen 1000 in FIG. 10A is a two-dimensional code display screen of the code payment application displayed on an information processing terminal apparatus, such as a smartphone, and a two-dimensional code 1001 is displayed. In the present embodiment, the code payment application uses one two-dimensional code, and the amount of data per code is about 20 bytes.

Next, two-dimensional codes to be utilized by the code job execution application will be described using FIG. 10B. Code job execution refers to execution of a job by using various pieces of job setting information contained in a two-dimensional code. The code job execution application in the image forming apparatus 100 uses the job setting information obtained from a two-dimensional code for job execution presented by the user to execute a job represented by the job type included in the two-dimensional code. A two-dimensional code for code job execution contains many pieces of information, such as the job type (such as copying, printing, or scanning) and job setting information. For example, for a copy job, the job setting information includes the number of copies to be printed, the magnification, the double-sided printing setting, the stapling setting, the sheet feed tray setting, and so on. For a scan job, the job setting information includes the color setting, the resolution, the double-sided scanning setting, the density, the saving destination, and so on. Thus, a two-dimensional code for code job execution needs to contain many pieces of information. For this reason, the data is sometimes divided and contained in multiple two-dimensional codes. A screen 1010 in FIG. 10B is a two-dimensional code display screen for the code job execution application displayed on an information processing terminal apparatus, such as a smartphone, on which a first two-dimensional code 1012 and a second two-dimensional code 1013 are displayed. In the present embodiment, the code job execution application uses two two-dimensional codes, and the amount of data per code is about 400 bytes.

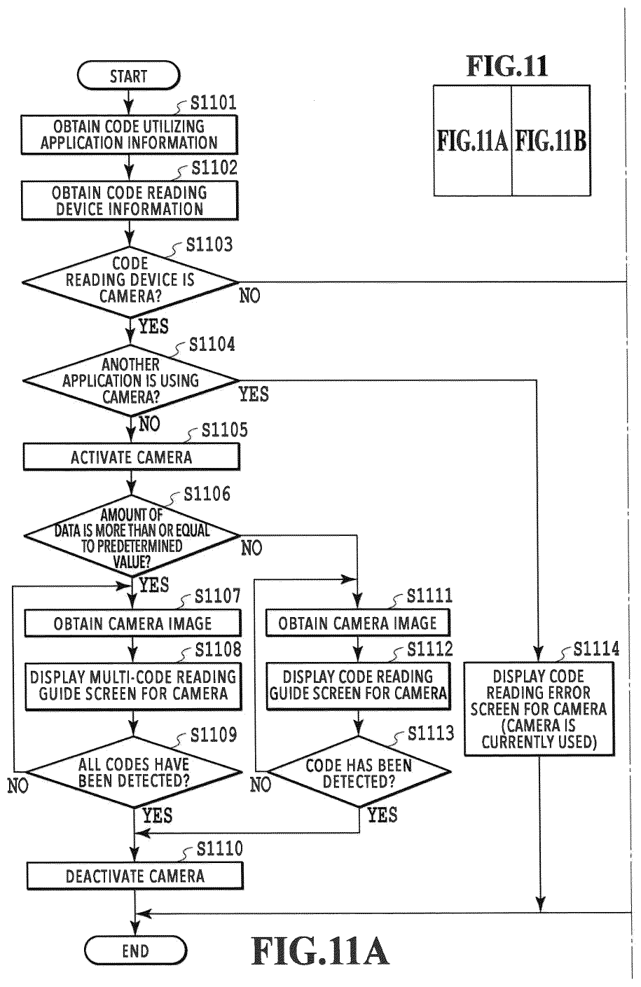

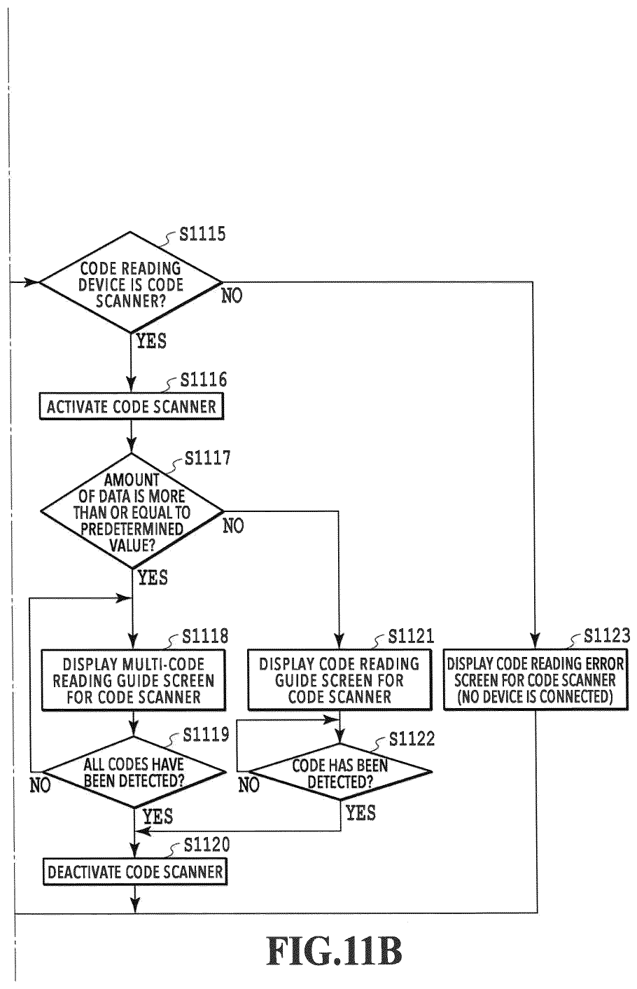

In the present embodiment, the processing for executing a code reading process in S502 is different from that in the first embodiment. Specifically, in the present embodiment, the processing in the flowchart illustrated in FIGS. 11A and 11B is performed in S502 instead of the processing illustrated in the flowchart of FIG. 7. FIGS. 11A and 11B are totally a flowchart illustrating details of a code reading process for reading a two-dimensional code or codes in the present embodiment. The processing in the flowchart illustrated in FIGS. 11A and 11B is processing that supports reading of multiple two-dimensional codes.

In S1101, the code reading control component 205 obtains code utilizing application information which is information on a code utilizing application from each processing component of the code utilizing application control component 210. For example, the code utilizing application information is information on the amount of encoded information to be utilized by various code utilizing applications. Specifically, the code utilizing application information is information indicating the total amount of data of a two-dimensional code of codes to be utilized by various code utilizing applications. In the present embodiment, the job execution processing component 212 has code utilizing application information with a data amount of 800 bytes, and the payment processing component 213 has code utilizing application information with a data amount of 20 bytes.

S1102 to S1105 are the same processes as S720 to S723 in the flow of FIG. 7, and description thereof is therefore omitted.

S1105 is followed by S1106, in which the code reading control component 205 determines whether or not the amount of data indicated by the code utilizing application information obtained in S1101 is more than or equal to a predetermined value (e.g., more than or equal to 400 bytes). The code reading control component 205 proceeds to S1107 if determining that the amount of data indicated by the code utilizing application information is more than or equal to the predetermined value (Yes in S1106). The code reading control component 205 proceeds to S1111 if determining that the amount of data indicated by the code utilizing application information is not more than or equal to the predetermined value (No in S1106).

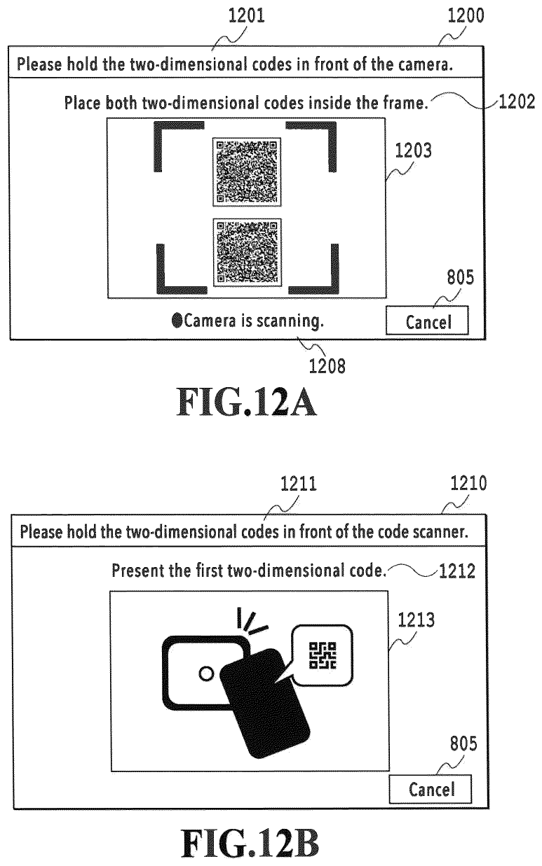

S1107 to S1109 are processes corresponding to a process of reading multiple two-dimensional codes. In S1107, the camera control component 203 obtains camera image data by the camera image capture process and sends the obtained camera image data to the code reading control component 205 and the UI control component 201. In S1108, the UI control component 201 displays a multi-code reading guide screen for the camera on the display screen of the operation unit 120. Details will be described later using FIG. 12A.

In S1109, the code reading control component 205 executes a process of detecting multiple two-dimensional codes from the camera image data obtained in S1107. Then, the code reading control component 205 determines whether the multiple two-dimensional codes have all been detected from the camera image data. The code reading control component 205 proceeds to S1110 if determining that the multiple two-dimensional codes have all been detected from the camera image data (Yes in S1109). The code reading control component 205 returns to S1107 if determining that not all of the two-dimensional codes have been detected from the camera image data (No in S1109).

Note that each two-dimensional code includes information on joining of the code (e.g., whether or not the code is joined, the order of the code, the total number of codes, etc.) in its header information, for example. The code reading control component 205 can determine whether the two-dimensional codes have all been detected based on this information on joining. Also, the process of S503 (a process of obtaining data from a read code) in the case of reading multiple two-dimensional codes will be a process of obtaining the two-dimensional codes decoded and joined as a single piece of data.

S1110 is the same process as S727 in FIG. 7. S1111 to S1113 are the same processes as S724 to S726 in FIG. 7. S1114 is the same process as S728 in FIG. 7. S1115 and S1116 are the same processes as S729 and S730 in FIG. 7.

S1116 is followed by S1117, in which the code reading control component 205 determines whether or not the amount of data indicated by the code utilizing application information obtained in S1101 is more than or equal to a predetermined value (e.g., more than or equal to 400 bytes). The code reading control component 205 proceeds to S1118 if determining that the amount of data indicated by the code utilizing application information is more than or equal to the predetermined value (Yes in S1117). The code reading control component 205 proceeds to S1121 if determining that the amount of data indicated by the code utilizing application information is not more than or equal to the predetermined value (No in S1117).

S1118 and S1119 are processes corresponding to a process of reading multiple two-dimensional codes. In S1118, the UI control component 201 displays a multi-code reading guide screen for the code scanner on the display screen of the operation unit 120. Details will be described later using FIG. 12B.

Then, in S1119, the code reading control component 205 determines whether the process of detecting multiple two-dimensional codes by the code scanner control component 204 has been completed. The code reading control component 205 proceeds to S1120 if determining that the code scanner control component 204 has detected all two-dimensional codes (Yes in S1119). The code reading control component 205 returns to S1118 if determining that the code scanner control component 204 has not detected all two-dimensional codes (No in S1119).

S1120 is the same process as S733 in FIG. 7. S1121 and S1122 are the same processes as S731 and S732 in FIG. 7. Also, S1123 is the same process as S734 in FIG. 7.

FIGS. 12A and 12B are diagrams illustrating code reading guide screens according to the present embodiment. FIG. 12A is an example of the code reading guide screen for the camera for multiple two-dimensional codes displayed in S1108. In a title region 1201 and a message region 1202 in a code reading guide screen 1200, text is displayed which helps the user simultaneously hold multiple two-dimensional codes in front of the camera 140. This display makes it possible for the camera 140 to capture the multiple two-dimensional codes within a single piece of camera image data. Accordingly, all of the two-dimensional codes can be detected in a single code reading process. An image region 1203 and a status region 1208 are similar to those in the example described with reference to FIG. 8A.

FIG. 12B is an example of the code reading guide screen for the code scanner for multiple two-dimensional codes displayed in S1118. In a title region 1211 and a message region 1212 in a code reading guide screen 1210, text is displayed which helps the user individually and sequentially hold multiple two-dimensional codes in front of the code scanner 150. After the first two-dimensional code is detected, the UI control component 201 updates the text on the code reading guide screen 1210 so as to give an instruction to read the next, second two-dimensional code. This display makes it possible to individually detect multiple two-dimensional codes with the code scanner 150 and detect all of the two-dimensional codes in multiple code reading processes. An image region 1213 is similar to that in the example described with reference to FIG. 8B.

As described above, in the present embodiment, the code reading guide screen to be displayed is switched and displayed according to information on the code utilizing application. This makes it easy for the user to read two-dimensional codes in a process of reading multiple two-dimensional codes without impairing the user operability.

Note that, in the present embodiment, an example has been described in which information on the total amount of data of the two-dimensional codes to be utilized by a code utilizing application is used as code utilizing application information. However, the code utilizing application information is not limited to this example. As the code utilizing application information, other information on the code utilizing application, such as information on the total number of two-dimensional codes to be utilized by the code utilizing application, may be used.

Also, in the present embodiment, an example has been described in which the code job execution application, which utilizes multiple two-dimensional codes, utilizes two two-dimensional codes has been described. Alternatively, the number of two-dimensional codes is not limited to two. Any number of two-dimensional codes can be utilized.

Further, in the present embodiment, an example has been described in which, in the case of using the camera 140, a process of switching the code reading guide screen to be displayed and a code reading process are performed to simultaneously read multiple two-dimensional codes. Alternatively, a method in which two-dimensional codes are read individually may be used. Similarly, in the case of using the code scanner 150 too, if the code scanner to be used is capable of simultaneously reading multiple two-dimensional codes, a process of switching the code reading guide screen to be displayed for the simultaneous reading may be performed.

### Third Embodiment

In the first embodiment and the second embodiment, examples have been described in which, in the case where either the camera 140 or the code scanner 150 is connected to the image forming apparatus, the code reading guide screen is switched according to the type of the connected code reading device. In a third embodiment, an example of switching the code reading guide screen in a case where both a camera and a code scanner are connected to the image forming apparatus will be described.

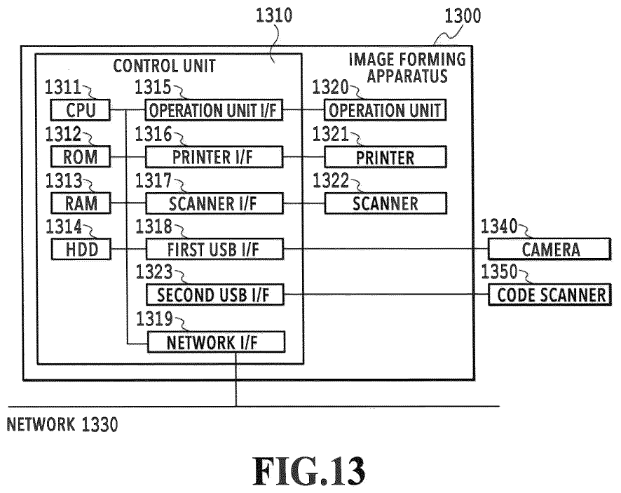

FIG. 13 is a block diagram illustrating a hardware configuration of the image forming apparatus according to the present embodiment. An image forming apparatus 1300 illustrated in FIG. 13 and the image forming apparatus 100 illustrated in FIG. 1 differ in that a control unit 1310 of the image forming apparatus 1300 has two USB I/Fs, namely a first USB I/F 1318 and a second USB I/F 1323, in place of the USB I/F 118. Also, a camera 1340 is connected to the image forming apparatus 1300 through the first USB I/F 1318, and a code scanner 1350 is connected to the image forming apparatus 1300 through the second USB I/F 1323. The other features of the hardware configuration are similar to those of the configuration described with reference to FIG. 1, and description thereof is therefore omitted.

In the present embodiment too, the processing in the flowchart illustrated in FIG. 5 is the same as that in the first embodiment. Note that, in the present embodiment, a CPU 1311 of the image forming apparatus 1300 implements the processing illustrated in FIG. 5 by functioning as the functional components of the application 200 illustrated in FIG. 2, as mentioned earlier. That is, the CPU 1311 implements the flowchart of FIG. 5 in the present embodiment by reading out a program stored in an ROM 1312, an HDD 1314, or the like into a RAM 1313 and executing it. Incidentally, the functions of some or all of the steps in FIG. 5 may be implemented with hardware, such as an ASIC or an electronic circuit.

In the present embodiment, the reading device determination process in S501 and the processing for executing a code reading process in S502 in FIG. 5 are different from those in the example described in the first embodiment. The difference from the first embodiment will be mainly described below.

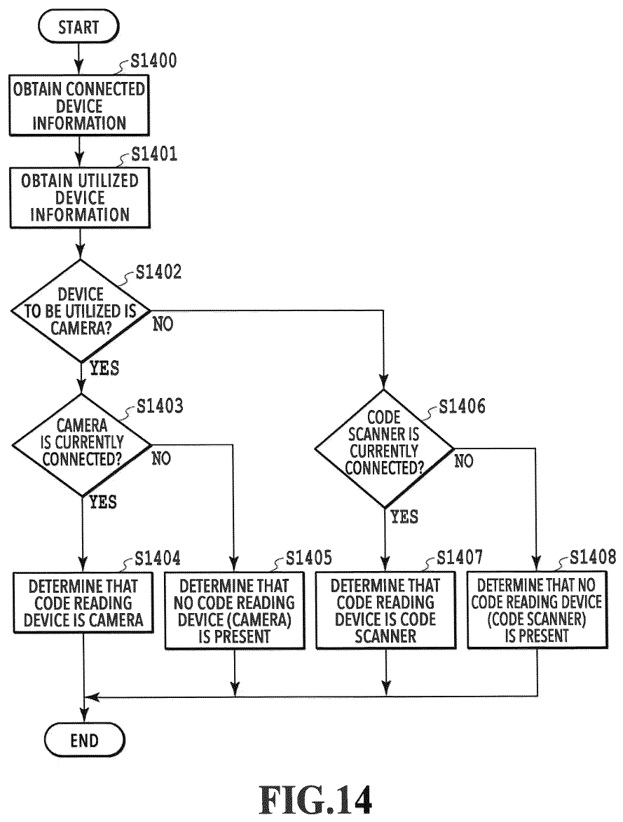

FIG. 14 is a flowchart illustrating details of the reading device determination process in S501 in the present embodiment. In the following, a process of determining a code reading device that is based on utilized device information will now be described below using the processing in the flowchart illustrated in FIG. 14. Note that the utilized device information refers to information which selects a reading device to be utilized in the code reading process and which is set by a code utilizing application or applications. For example, only the code scanner 1350 is set as a device to be utilized for the “Code payment for printing” button 305.

In S1400, the code reading control component 205 obtains the connected device information of the camera 1340 and the code scanner 1350. In the first embodiment, an example in which the connected device is either a camera or a code scanner or neither of them is connected has been described. In the present embodiment, the connected device may be either one of a camera or a code scanner or both of the camera and the code scanner, or neither of them may be connected.

In S1401, the code reading control component 205 obtains the utilized device information for the code reading process. In S1402, the code reading control component 205 determines whether to utilize the camera 1340 for the code reading based on the utilized device information obtained in S1401. The code reading control component 205 proceeds to S1403 if determining that the camera 1340 is the device to be utilized based on the utilized device information (Yes in S1402). The code reading control component 205 proceeds to S1406 if determining that the device to be utilized is not the camera 1340 (No in S1402).

In S1403, the code reading control component 205 determines whether the camera 1340 is currently connected based on the connected device information obtained in S1400. The code reading control component 205 proceeds to S1404 if determining that the camera 1340 is currently connected (Yes in S1403). The code reading control component 205 proceeds to S1405 if determining that the camera is not currently connected (No in S1403).

In S1404, the code reading control component 205 determines that the code reading device is the camera. Then, the code reading control component 205 terminates the processing in the flowchart illustrated in FIG. 14. In S1405, the code reading control component 205 determines that no camera is present as a code reading device. Then, the code reading control component 205 terminates the processing in the flowchart illustrated in FIG. 14.

In S1406, the code reading control component 205 determines whether the code scanner 1350 is currently connected based on the connected device information obtained in S1400. The code reading control component 205 proceeds to S1407 if determining that the code scanner 1350 is currently connected (Yes in S1406). The code reading control component 205 proceeds to S1408 if determining that the code scanner 1350 is not currently connected (No in S1406).

In S1407, the code reading control component 205 determines that the code reading device is the code scanner 1350. Then, the code reading control component 205 terminates the processing in the flowchart illustrated in FIG. 14. In S1408, the code reading control component 205 determines that no code scanner is present as a code reading device. Then, the code reading control component 205 terminates the processing in the flowchart illustrated in FIG. 14.

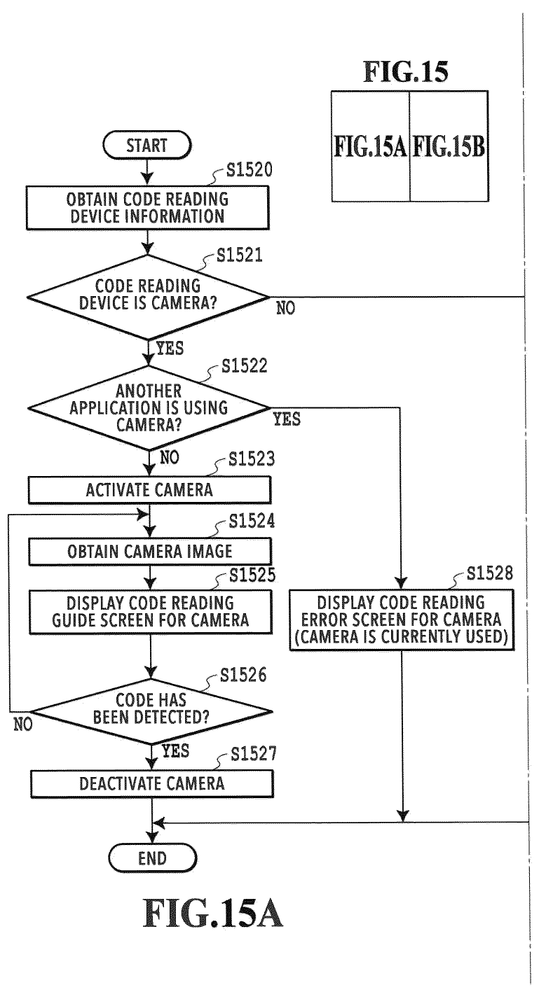

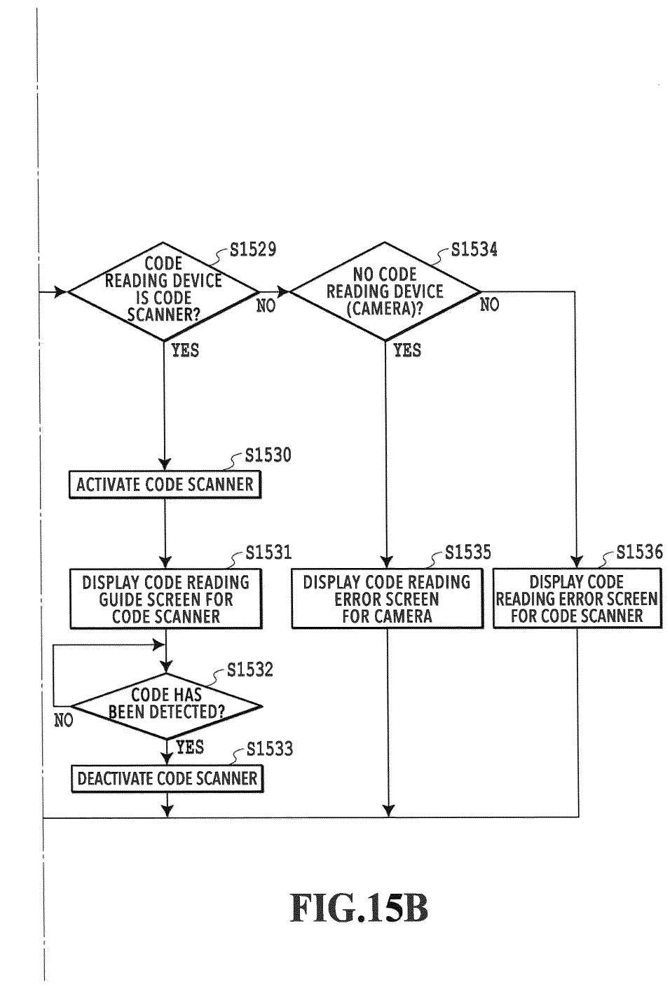

FIGS. 15A and 15B are totally a flowchart illustrating details of the processing for executing a code reading process in S502 in the present embodiment.

S1520 to S1533 are the same processes as S720 to S733 in the flow of FIG. 7, and description thereof is therefore omitted. Note that the code reading device information obtained in S1520 is one of “camera,” “no camera”, “code scanner,” or “no code scanner. “Also, if determining in S1529 that the code reading device is not a code scanner (that is, if determining that the code reading device is neither a camera nor a code scanner), the code reading control component 205 proceeds to S1534.

In S1534, the code reading control component 205 determines whether the code reading device information obtained in S1520 is “no camera.” The code reading control component 205 proceeds to S1535 if determining that the code reading device information is “no camera” (Yes in S1534). The code reading control component 205 proceeds to S1536 if determining that the code reading device information is not “no camera” (No in S1534).

In S1535, the UI control component 201 displays a code reading error screen for the camera on the display screen of an operation unit 1320. In doing so, the UI control component 201 indicates that the camera 1340 set as a device that may be utilized is not connected. Then, the code reading control component 205 terminates the processing in the flowchart illustrated in FIGS. 15A and 15B.

In S1536, the UI control component 201 displays a code reading error screen for the code scanner on the display screen of the operation unit 1320. In doing so, the UI control component 201 indicates that the code scanner 1350 set as a device that may be utilized is not connected. Then, the code reading control component 205 terminates the processing in the flowchart illustrated in FIGS. 15A and 15B.

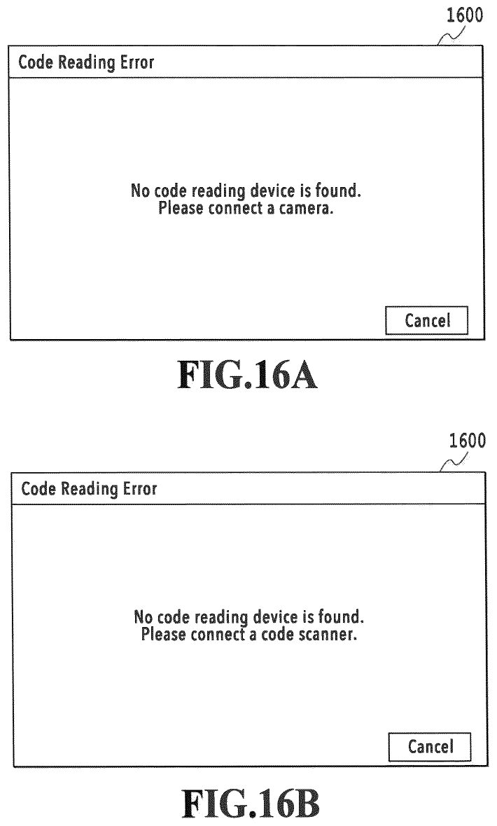

FIGS. 16A and 16B are diagrams illustrating an example of the code reading error screens according to the present embodiment. FIG. 16A is an example of the code reading error screen displayed in S1535 in the case where the camera 1340 as a device that may be utilized is not connected. FIG. 16B is an example of the code reading error screen displayed in S1536 in the case where the code scanner 1350 as a device that may be utilized is not connected. As illustrated in FIGS. 16A and 16B, a code reading guide screen 1600 displays text indicating that the camera or code scanner set as a device that may be utilized is not connected.

The above has described a process using utilized device information in a case where both a camera and a code scanner can be connected to the image forming apparatus. Next, a description will be given of a process using priority device information, which is information different from the utilized device information, in the case where both a camera and a code scanner can be connected to the image forming apparatus. The priority device information refers to information which selects a device to be preferentially utilized in code reading processes. The priority device information may include information which enables or disables permission to change the device in a case where the priority device is not connected in order to utilize another currently connected device. The priority device information is set by a code utilizing application or applications.

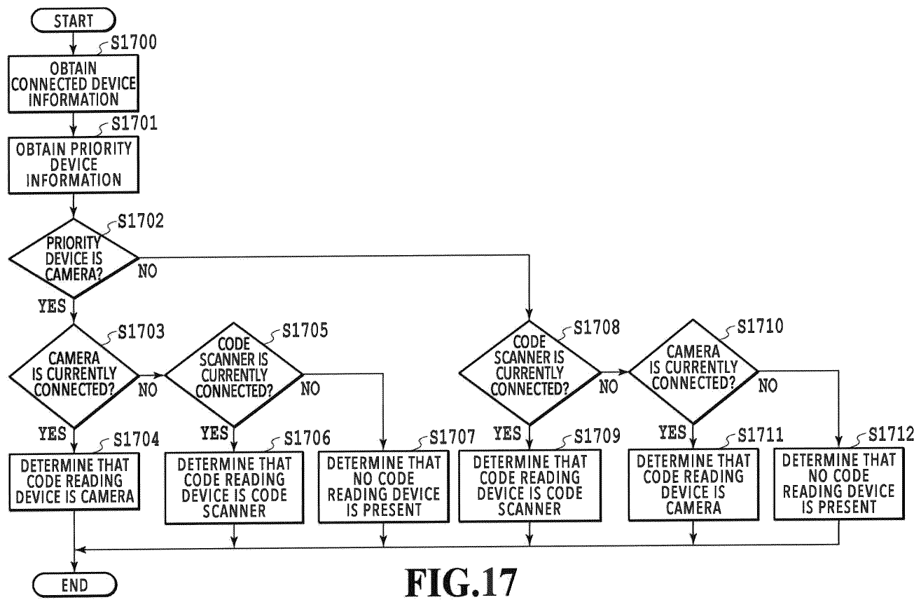

FIG. 17 is a flowchart illustrating details of another example of the reading device determination process in S501 in the present embodiment. The processing in the flowchart illustrated in FIG. 17 differs from the processing in the flowchart illustrated in FIG. 14 in that processing based on the priority device information is performed.

S1700 is the same process as S1400. In S1701, the code reading control component 205 obtains the priority device information for the code reading process. In S1702, the code reading control component 205 determines whether to prioritize the camera 1340 for the code reading based on the priority device information obtained in S1701. The code reading control component 205 proceeds to S1703 if determining that the priority device is the camera 1340 (Yes in S1702). The code reading control component 205 proceeds to S1708 if determining that the priority device is not the camera 1340 (No in S1702).

In S1703, the code reading control component 205 determines whether the camera 1340, which is the priority device, is currently connected based on the connected device information obtained in S1700. The code reading control component 205 proceeds to S1704 if determining that the camera 1340 is currently connected (Yes in S1703). The code reading control component 205 proceeds to S1705 if determining that the camera 1340 is not currently connected (No in S1703).

In S1704, the code reading control component 205 determines that the code reading device is the camera 1340. Then, the code reading control component 205 terminates the processing in the flowchart illustrated in FIG. 17.

In S1705, the code reading control component 205 determines whether the code scanner 1350, which is not the priority device, is currently connected based on the connected device information obtained in S1700. The code reading control component 205 proceeds to S1706 if determining that the code scanner 1350 is currently connected (Yes in S1705). The code reading control component 205 proceeds to S1707 if determining that the code scanner 1350 is not currently connected (No in S1705).

In S1706, the code reading control component 205 determines that the code reading device is the code scanner 1350. Then, the code reading control component 205 terminates the processing in the flowchart illustrated in FIG. 17.

In S1707, the code reading control component 205 determines that the code reading device is not present. Then, the code reading control component 205 terminates the processing in the flowchart illustrated in FIG. 17.

In S1708, the code reading control component 205 determines whether the code scanner 1350, which is the priority device, is currently connected based on the connected device information obtained in S1700. The code reading control component 205 proceeds to S1709 if determining that the code scanner 1350 is currently connected (Yes in S1708). The code reading control component 205 proceeds to S1710 if determining that the code scanner 1350 is not currently connected (No in S1708).

In S1709, the code reading control component 205 determines that the code reading device is the code scanner 1350. Then, the code reading control component 205 terminates the processing in the flowchart illustrated in FIG. 17.

In S1710, the code reading control component 205 determines whether the camera 1340, which is not the priority device, is currently connected based on the connected device information obtained in S1700. The code reading control component 205 proceeds to S1711 if determining that the camera is currently connected (Yes in S1710). The code reading control component 205 proceeds to S1712 if determining that the camera is not currently connected (No in S1710).

In S1711, the code reading control component 205 determines that the code reading device is the camera 1340. Then, the code reading control component 205 terminates the processing in the flowchart illustrated in FIG. 17.

In S1712, the code reading control component 205 determines that the code reading device is not present. Then, the code reading control component 205 terminates the processing in the flowchart illustrated in FIG. 17.

Incidentally, the description of the processing in FIG. 17 has set forth an example of processing in a case where the priority device information is information which selects the device to be preferentially utilized in code reading processes. As described earlier, the priority device information may include information which enables or disables permission to change the device in a case where the priority device is not connected in order to utilize another currently connected device. In a case where the priority device information includes information which enables or disables permission to change the device, the determination process in S1705 in FIG. 17 may additionally involve determining whether permission to change the device is enabled. Specifically, the configuration may be such that, if the code scanner 1350 is currently connected and permission to change the device is enabled in S1705, the processing proceeds to S1706 and, if not, the processing proceeds to S1707. Similarly, the configuration may be such that, if the camera 1340 is currently connected and permission to change the device is enabled in S1710, the processing proceeds to S1711 and, if not, the processing proceeds to S1712.

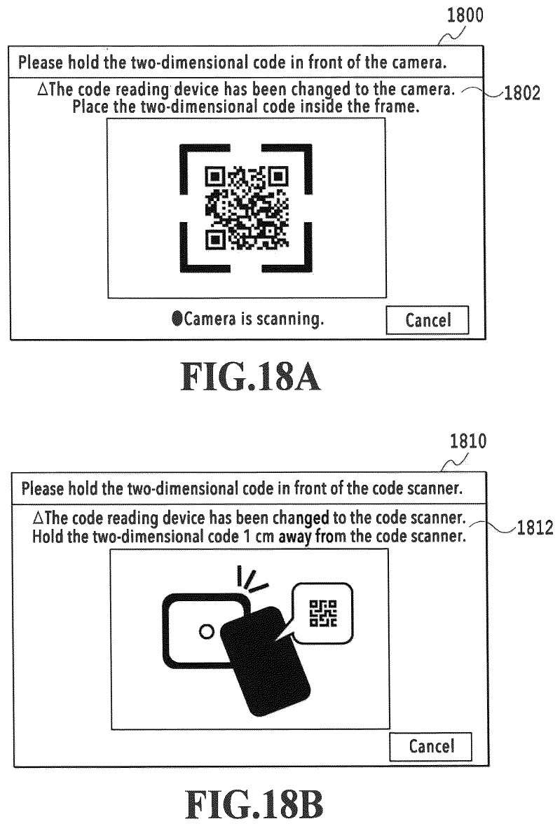

FIGS. 18A and 18B are diagrams illustrating an example of the code reading guide screens according to the present embodiment. FIG. 18A is an example of the code reading guide screen for the camera in a case where the code scanner 1350 as the priority device is not connected and changing the device to another code reading device is permitted. On a code reading guide screen 1800, text indicating that the device to be utilized in the code reading has been changed from the code scanner, which is the priority device, to a camera is displayed in a message region 1802.

FIG. 18B is an example of the code reading guide screen for the code scanner in a case where the camera 1340 as the priority device is not connected and changing the device to another code reading device is permitted. On a code reading guide screen 1810, text indicating that the device to be utilized in the code reading has been changed from the camera, which is the priority device, to a code scanner is displayed in a message region 1812.

Note that, while examples based on the assumption that the priority device information includes information on permission to change the device have been described above, the screens can be similar to those in FIGS. 18A and 18B also in a case of not using the information on permission to change the device.

The above has described a process using priority device information in a case where both a camera and a code scanner can be connected to the image forming apparatus. Next, an example of determining the code reading device based on the order of connection in a case where both a camera and a code scanner can be connected to the image forming apparatus will be described.

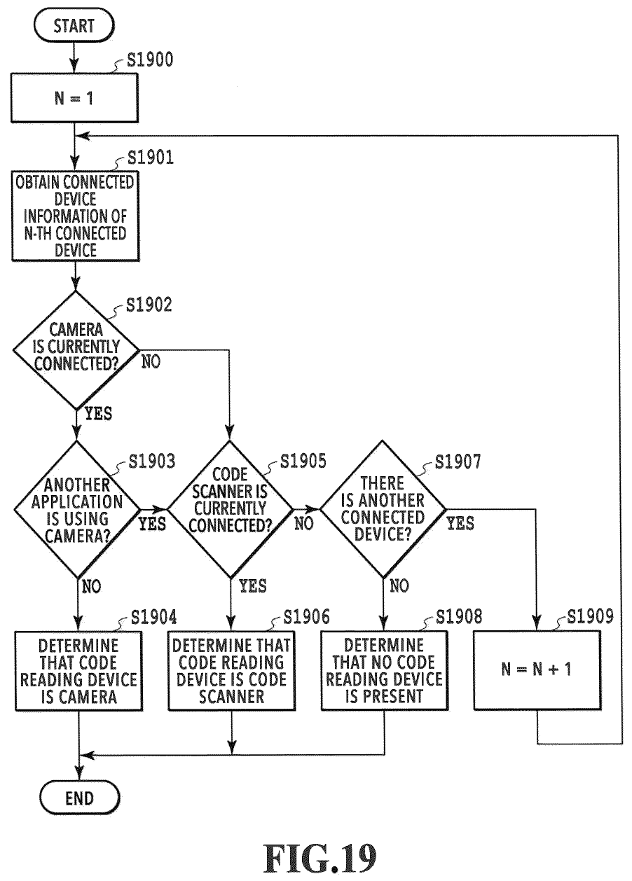

FIG. 19 is a flowchart illustrating details of another example of the reading device determination process in S501 in the present embodiment. The processing illustrated in FIG. 19 differ from those illustrated in FIGS. 14 and 17 in that the code reading device to be utilized is automatically determined according to the order of connection of the camera 1340 or the code scanner 1350 currently connected to the image forming apparatus 1300.

In S1900, the code reading control component 205 sets a connected device number N to 1 (N=1). In S1901, the code reading control component 205 obtains the connected device information of the camera 1340 or the code scanner 1350, whichever is the N-th device connected to the image forming apparatus 1300. Here, the order of connection of each code reading device is determined based on which of the camera 1340 and the code scanner 1350 was connected at an earlier time (or a later time) to the first USB I/F 1318 or the second USB I/F 1323. Alternatively, the order of connection may be determined based on the order of the USB I/Fs' numbers such that the first USB I/F 1318 corresponds to the first device and the second USB I/F corresponds to the second device.

In S1902, the code reading control component 205 determines whether the camera is currently connected based on the connected device information of the N-th connected device obtained in S1901. The code reading control component 205 proceeds to S1903 if determining that the camera is currently connected (Yes in S1902). The code reading control component 205 proceeds to S1905 if determining that the camera is not currently connected (No in S1902).

In S1903, the code reading control component 205 determines whether another application is using the camera 1340. The code reading control component 205 proceeds to S1904 if determining that another application is not using the camera 1340 (No in S1903). The code reading control component 205 proceeds to S1905 if determining that another application is using the camera 1340 (Yes in S1903).

In S1904, the code reading control component 205 determines that the code reading device is the camera 1340. Then, the code reading control component 205 terminates the processing in the flowchart illustrated in FIG. 19.

In S1905, the code reading control component 205 determines whether the code scanner is currently connected based on the connected device information of the N-th connected device obtained in S1901. The code reading control component 205 proceeds to S1906 if determining that the code scanner is currently connected (Yes in S1905). The code reading control component 205 proceeds to S1907 if determining that the code scanner is not currently connected (No in S1905).

In S1906, the code reading control component 205 determines that the code reading device is the code scanner 1350. Then, the code reading control component 205 terminates the processing in the flowchart illustrated in FIG. 19.

In S1907, the code reading control component 205 determines whether there is connected device information of a device other than the camera 140 and the code scanner 150. The code reading control component 205 proceeds to S1909 if determining that there is connected device information of another device (Yes in S1907). The code reading control component 205 proceeds to S1908 if determining that there is not connected device information of another device (No in S1907).

In S1908, the code reading control component 205 determines that the code reading device is not present. Then, the code reading control component 205 terminates the processing in the flowchart illustrated in FIG. 19.

In S1909, the code reading control component 205 sets the connected device number N to N+1 (N=N+1), returns to S1901, and repeats the procedure.

As described above, in the present embodiment, in a case where both a camera and a code scanner can be connected, one of them is determined as the code reading devices according to predetermined criteria. In this way, the code reading guide screen to be displayed can be switched according to the type of the code reading device. The predetermined criteria are the utilized device information, the priority device information, and the order of connection. Incidentally, in the present embodiment, the user's selection may be used as a predetermined criterion. Specifically, the code reading device may be determined based on the user's selection.

### Fourth Embodiment

In the third embodiment, an example has been described in which, in a case where both a camera and a code scanner are connected, one of the code reading devices is utilized to switch the code reading guide screen. In a fourth embodiment, an example will be described in which, in a case where both a camera and a code scanner are connected, both of the code reading devices are utilized to execute the code reading process. The configuration of an image forming apparatus 1300 in the present embodiment is similar to that in the example described in the third embodiment.

In the present embodiment too, the processing in the flowchart illustrated in FIG. 5 is the same as that in the first embodiment. As described in the third embodiment too, the CPU 1311 of the image forming apparatus 1300 in the present embodiment implements the processing illustrated in FIG. 5 by functioning as the functional components of the application 200 illustrated in FIG. 2, as mentioned earlier. That is, the CPU 1311 implements the flowchart of FIG. 5 in the present embodiment by reading out a program stored in the ROM 1312, the HDD 1314, or the like into the RAM 1313 and executing it.

In the present embodiment, the reading device determination process in S501 and the processing for executing a code reading process in S502 in FIG. 5 are different from those in the example described in the first embodiment. The difference from the first embodiment will be mainly described below.

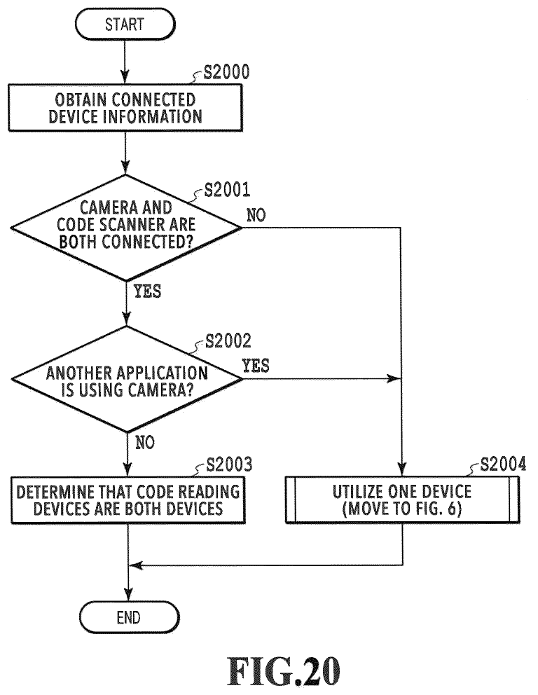

FIG. 20 is a flowchart illustrating details of the reading device determination process in S501 in the present embodiment. In the following, an example of executing a code reading process by utilizing both the camera 1340 and the code scanner 1350 as code reading devices will be described using the flowchart illustrated in FIG. 20.

In S2000, the code reading control component 205 obtains the connected device information of the camera 1340 and the code scanner 1350. In S2001, the code reading control component 205 determines whether the camera and the code scanner are currently connected based on the connected device information obtained in S2000. The code reading control component 205 proceeds to S2002 if determining that the camera and the code scanner are currently connected (Yes in S2001). The code reading control component 205 proceeds to S2004 if determining that the camera and the code scanner are not currently connected (No in S2001).

In S2002, the code reading control component 205 determines whether another application is using the camera 1340. The code reading control component 205 proceeds to S2003 if determining that another application is not using the camera 1340 (No in S2002). The code reading control component 205 proceeds to S2004 if determining that another application is using the camera 1340 (Yes in S2003).

In S2003, the code reading control component 205 determines that the code reading devices are the camera 1340 and the code scanner 1350. Then, the code reading control component 205 terminates the processing in the flowchart illustrated in FIG. 20.

In S2004, the code reading control component 205 performs a process corresponding to S501 in the first embodiment or the second embodiment illustrated in FIG. 6 since the camera 1340 and the code scanner 1350 are not currently connected. That is, a code reading device determination process for a case of utilizing one of the camera or the code scanner is performed. Then, the code reading control component 205 terminates the processing in the flowchart illustrated in FIG. 20.

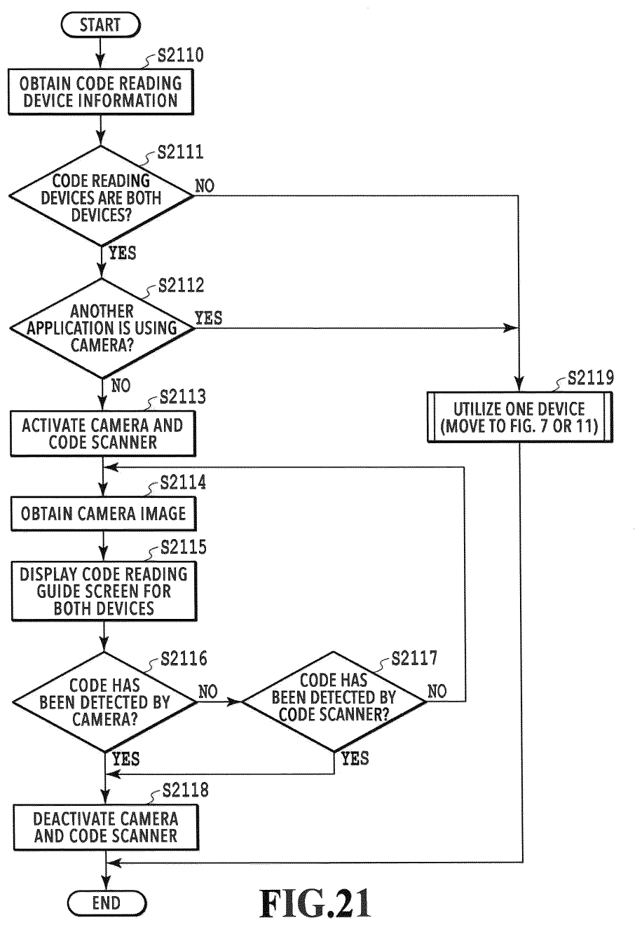

FIG. 21 is a flowchart illustrating details of the processing for executing a code reading process in S502 in the present embodiment.

In S2110, the code reading control component 205 obtains code reading device information. In S2111, the code reading control component 205 determines whether the code reading device information obtained in S2110 indicates both devices, namely the camera 1340 and the code scanner 1350. The code reading control component 205 proceeds to S2112 if determining that the code reading device information indicates both devices (camera 1340 and the code scanner 1350) (Yes in S2111). The code reading control component 205 proceeds to S2119 if determining that the code reading device information does not indicate both devices (camera 1340 and code scanner 1350) (No in S2111).

In S2112, the code reading control component 205 determines whether another application is using the camera 1340. The code reading control component 205 proceeds to S2119 if determining that another application is using the camera 1340 (Yes in S2112). The code reading control component 205 proceeds to S2113 if determining that another application is not using the camera 1340 (No in S2112).

In S2113, the code reading control component 205 activates both the camera 1340 and the code scanner 1350. Specifically, the code reading control component 205 sends an instruction to activate the camera 1340 to the camera control component 203, and the camera control component starts a camera image capture process. Also, the code reading control component 205 notifies the UI control component 201 that the camera has started capturing an image. Also, the code scanner control component 204 activates the code scanner 1350 based on the instruction from the code reading control component 205.

Then, in S2114, the camera control component 203 obtains camera image data by the camera image capture process and sends the obtained camera image data to the code reading control component 205 and the UI control component 201.

Then, in S2115, the UI control component 201 displays a code reading guide screen for both devices, namely the camera and the code scanner, on the display screen of the operation unit 120. In doing so, the UI control component 201 displays also a status indicator indicating that the camera 140 is capturing an image.

Then, in S2116, the code reading control component 205 executes a process of detecting a two-dimensional code from the camera image data obtained in S2114. The code reading control component 205 proceeds to S2118 if determining that a two-dimensional code has been detected from the camera image data (Yes in S2116). The code reading control component 205 proceeds to S2117 if determining that no two-dimensional code has been detected from the camera image data (No in S2116).

In S2117, the code reading control component 205 determines whether the code detection process by the code scanner control component 204 has been completed. The code reading control component 205 proceeds to S2118 if determining that the code scanner control component 204 has detected a two-dimensional code (Yes in S2117). The code reading control component 205 returns to S2114 if determining that the code scanner control component 204 has not detected a two-dimensional code (No in S2117).

In S2118, the code reading control component 205 terminates the code detection process with both devices, namely the camera 1340 and the code scanner 1350. At this time, the camera control component 203 deactivates the camera 1340 and notifies the UI control component 201 that the image capture by the camera has been stopped. Also, the code scanner control component 204 deactivates the code scanner 1350. Then, the code reading control component 205 terminates the processing in the flowchart illustrated in FIG. 21.

In S2119, the code reading control component 205 proceeds to the processing in the flowchart illustrated in FIG. 7 or 11, which illustrates details of S502 in FIG. 5, since the code reading device information does not indicate both devices, namely, the camera and the code scanner. Specifically, the code reading control component 205 executes a code reading process for a case of utilizing one of the camera or the code scanner. Then, the code reading control component 205 terminates the processing in the flowchart illustrated in FIG. 21.

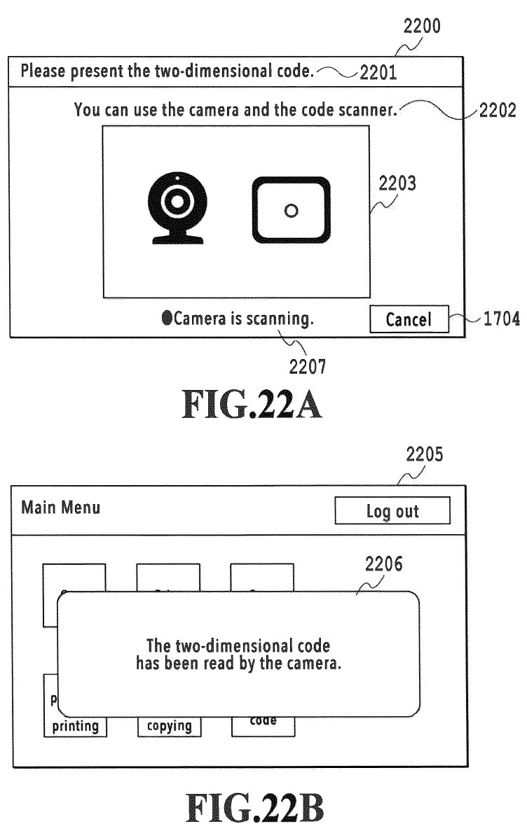

FIGS. 22A and 22B are diagrams illustrating an example of the code reading guide screen according to the present embodiment. FIG. 22A is an example of the code reading guide screen in a case of executing a code reading process utilizing both devices, namely the camera and the code scanner. A code reading guide screen 2200 indicates in a message region 2202 and an image region 2203 that both the camera and the code scanner are devices that may be utilized for the code reading and that either of the devices can be utilized to read the two-dimensional code. Also, in a status region 2207, the code reading guide screen 2200 indicates to the user that the camera 140 is capturing an image.

FIG. 22B is an example of a screen after the completion of the reading of the two-dimensional code by the code reading process utilizing both devices, namely the camera and the code scanner. Here, the code utilizing application is an application that executes a login process. The user holds the two-dimensional code in front of the camera 1340 to get the code read. The display on the display screen switches from the code reading guide screen 2200 to a code utilizing application screen 2205 after the completion of the code reading, displaying a pop-up 2206 indicating that the two-dimensional code has been read by the camera. In this way, the user can confirm that the user held the two-dimensional code in front of the camera 1340 and the code was read.

As described above, in a case where both a camera and a code scanner are connected, the code reading guide screen to be displayed can be switched to one utilizing both devices, namely the camera and the code scanner, by determining both devices to be code reading devices.

Note that, in the present embodiment, a case where one camera and one code scanner are included and a total of two code reading devices are utilized has been described, but the number of devices is not limited to two. Also, multiple devices of the same type may be used. For example, two cameras may be provided. The screen may be switched according to the performance of the connected camera. Also, two cameras with the same performance may be provided, for example. In such a case too, the screen to be displayed is switched according to the connected device since the content of the notification of where the camera is placed is different.

### Other Embodiments

Each of the above embodiments has been described using an image forming apparatus with a printer and a scanner as an example of an information processing apparatus, but is not limited to this example. The above embodiments are applicable to information processing apparatuses in general to which cameras and code scanners can be connected.

Also, in each of the above embodiments, an example has been described in which payment ID information is contained in two-dimensional codes for the “Code payment for printing” button 305 and the “Code payment for copying” button 306, but various types of information may be included in addition to the payment ID information. For example, the job setting information described earlier may be included in two-dimensional codes to be used for the “Code payment for printing” button 305 and the “Code payment for copying” button 306. Likewise, payment ID information may be included in two-dimensional codes to be user for the “Execute job with code” button 307.

Also, a configuration combining the third embodiment or the fourth embodiment and the second embodiment may be employed. Specifically, code utilizing application information may be obtained in the processing for executing a code reading process in the third embodiment or the fourth embodiment. Then, a multi-code reading guide as described in the second embodiment may be displayed based on the amount of data indicated by the code utilizing application information.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to improve the usability of an information processing apparatus which uses encoded information as input information.

This application claims the benefit of Japanese Patent Application No. 2024-165517, filed Sep. 24, 2024, which is hereby incorporated by reference herein in its entirety.

What is claimed is:

1. An information processing apparatus comprising:
one or more memories storing instructions; and
one or more processors which function as:
a determination unit configured to determine a reading device for reading encoded information from among a plurality of the reading devices, the reading devices being connectable to the information processing apparatus;
a display control unit configured to cause a display unit to display a guide screen corresponding to the reading device determined by the determination unit from among the plurality of connectable reading devices; and
a control unit configured to perform control for reading the encoded information by using the reading device determined by the determination unit.

2. The information processing apparatus according to claim 1, wherein the guide screen includes a message for notifying of a reading method using the reading device.

3. The information processing apparatus according to claim 1, wherein the guide screen includes a message for notifying of a position on the information processing apparatus at which the reading device is provided.

4. The information processing apparatus according to claim 1, wherein
the determination unit determines the reading device on a basis of reception of an instruction to launch an application that utilizes the encoded information, and
the control unit performs a process for the application by using a result of decoding of the read encoded information.

5. The information processing apparatus according to claim 4, wherein the information processing apparatus is configured such that one reading device among the plurality of connectable reading devices is connectable to the information processing apparatus.

6. The information processing apparatus according to claim 5, wherein the plurality of connectable reading devices include a camera and a code scanner.

7. The information processing apparatus according to claim 6, wherein the display control unit causes the display unit to display one screen among a first screen for a camera, a second screen for a code scanner, a third screen indicating an error in a case where the determined reading device is a camera, and a fourth screen indicating an error in a case where no device is connected according to the determined reading device.

8. The information processing apparatus according to claim 7, wherein the first screen includes a display including an image captured by the camera and a frame superimposed on the image.

9. The information processing apparatus according to claim 8, wherein the display control unit does not display the image and the frame on the first screen in a case where a size of the display unit is smaller than a predetermined size.

10. The information processing apparatus according to claim 7, wherein the first screen includes a status indicator indicating that the camera is capturing an image.

11. The information processing apparatus according to claim 7, wherein the display control unit causes the display unit to display the third screen in a case where a second application different from the application is utilizing a camera in a state where the determined reading device is the camera.

12. The information processing apparatus according to claim 4, wherein the application includes one of login, code payment, or code job execution.

13. The information processing apparatus according to claim 4, wherein the control unit activates the reading device determined by the determination unit on a basis of reception of an instruction to launch the application, and deactivates the activated reading device in a case where reading of the encoded information is completed.

14. The information processing apparatus according to claim 4, wherein
the one or more processors further function as an obtaining unit configured to obtain application information on an amount of the encoded information to be utilized by the application, and
the display control unit causes the display unit to display a guide screen, as the guide screen, for notifying of a guide to read a plurality of the pieces of encoded information in a case where the amount of the encoded information indicated by the application information is more than or equal to a predetermined value.

15. The information processing apparatus according to claim 4, wherein the information processing apparatus is configured such that a plurality of reading devices among the plurality of connectable reading devices are simultaneously connectable to the information processing apparatus.

16. The information processing apparatus according to claim 15, wherein
the one or more processors further function as an obtaining unit configured to obtain utilized device information indicating a reading device set as a reading device to be utilized by the application, and
in a case where the reading device indicated by the utilized device information is connected to the information processing apparatus, the determination unit determines the connected reading device to be the reading device for reading the encoded information.

17. The information processing apparatus according to claim 15, wherein
the one or more processors further function as an obtaining unit configured to obtain priority device information indicating a reading device to be preferentially utilized, wherein
in a case where the reading device indicated by the priority device information is connected to the information processing apparatus, the determination unit determines the connected reading device to be the reading device for reading the encoded information.

18. The information processing apparatus according to claim 15, wherein the determination unit determines the reading device for reading the encoded information based on an order of connection of reading devices connected to the information processing apparatus.

19. A method of controlling an information processing apparatus, the method comprising:
determining a reading device for reading encoded information from among a plurality of the reading devices, the reading devices being connectable to the information processing apparatus;
causing a display unit to display a guide screen corresponding to the reading device determined from among the plurality of connectable reading devices; and
performing control for reading the encoded information by using the determined reading device.

20. A non-transitory computer readable storage medium storing a program which causes a computer to execute:
determining a reading device for reading encoded information from among a plurality of the reading devices, the reading devices being connectable to the information processing apparatus;
causing a display unit to display a guide screen corresponding to the reading device determined from among the plurality of connectable reading devices; and
performing control for reading the encoded information by using the determined reading device.
